(19) United States
(12) Patent Application Publication
(10) Pub. No.: US 2026/0264711 A1
(43) Pub. Date: Sep. 10, 2026

(54) VEHICLE CONTROL DEVICE, VEHICLE, AND VEHICLE CONTROL METHOD

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Tadashi OMACHI, Tokyo (JP); Shingo MORISHITA, Tokyo (JP); Yuki TEZUKA, Toyota-shi (JP); Koichi GUNYA, Obu-shi (JP)

(21) Appl. No.: 19/463,787

(22) Filed: Jan. 29, 2026

(30) Foreign Application Priority Data
Feb. 4, 2025 (JP) 2025-016973

(51) Int. Cl. B60W 50/14; B60W 60/00; G06V 20/58

(52) U.S. Cl. CPC B60W 50/14; B60W 60/0053; B60W 60/0059; G06V 20/58; B60W 2050/143; B60W 2050/146; B60W 2420/403

(57) ABSTRACT

A vehicle includes a steering wheel and a notification device. The notification device notifies a request to a driver of an own vehicle. A vehicle control device is applicable to the vehicle. The vehicle control device performs hands-off control that causes the own vehicle to travel in a hands-off state in which the driver is not holding the steering wheel. The vehicle control device outputs a hands-on request to the notification device on the basis that the hands-off control is being performed and there is a potential for at least a portion of a vehicle traveling in an own vehicle lane in which the own vehicle is traveling and at least a portion of a vehicle traveling in an opposing lane to enter each other's lanes. The hands-on request requests transition to a hands-on state in which the driver is holding the steering wheel.

### CROSS-REFERENCE TO RELATED APPLICATION

This application is based on and claims the benefit of priority from earlier Japanese Patent Application No. 2025-016973 filed Feb. 4, 2025, the description of which is incorporated herein by reference.

### BACKGROUND OF THE INVENTION

### Technical Field

The present disclosure relates to a vehicle control device performing hands-off control and a vehicle control method.

### Background Art

For example, there is a vehicle control device that notifies a hands-on request in a case where future lateral acceleration is greater than a threshold.

### SUMMARY

In the present disclosure, provided is a vehicle control device as the following.

The vehicle control device applicable to a vehicle includes:

at least one of (i) a circuit and (ii) a processor with a memory storing computer program code executable by the processor, the at least one of the circuit and the processor configured to cause the vehicle control device to:

perform hands-off control that causes an own vehicle to travel in a hands-off state in which a driver is not holding a steering wheel; and

output a hands-on request to a notification device included in the vehicle on a basis that (i) the hands-off control is being performed and (ii) there is a potential for at least a portion of a vehicle traveling in an own vehicle lane in which the own vehicle is traveling and at least a portion of a vehicle traveling in an opposing lane to enter each other's lanes, the hands-on request requesting transition to a hands-on state in which the driver is holding the steering wheel.

In the present disclosure, also provided is a vehicle control method as follows.

The vehicle control method for a vehicle includes:

performing hands-off control that causes an own vehicle to travel in a hands-off state in which a driver is not holding a steering wheel; and

outputting a hands-on request to a notification device included in the vehicle on a basis that (i) the hands-off control is being performed and (ii) there is a potential for at least a portion of a vehicle traveling in an own vehicle lane in which the own vehicle is traveling and at least a portion of a vehicle traveling in an opposing lane to enter each other's lanes, the hands-on request requesting transition to a hands-on state in which the driver is holding the steering wheel.

### BRIEF DESCRIPTION OF THE DRAWINGS

FIG. 1 is a block diagram of a vehicle.

FIG. 2 is a flowchart illustrating a procedure of a hands-on request.

FIG. 3 is a flowchart illustrating a procedure of an oncoming vehicle determination.

FIG. 4 is a flowchart illustrating a procedure of a three-dimensional structure determination.

FIG. 5 is a schematic diagram illustrating an example of a three-dimensional structure.

FIG. 6 is a schematic diagram illustrating an example of a road having no median strip.

FIG. 7 is a flowchart illustrating a procedure of an unseparated oncoming vehicle determination.

FIG. 8 is a flowchart illustrating a procedure of a detection history determination.

FIG. 9 is a flowchart illustrating a procedure of a definitive determination.

FIG. 10 is a schematic diagram illustrating a median strip including intermittent poles.

FIG. 11 is a schematic diagram illustrating a median strip including wire ropes.

FIG. 12 is a flowchart illustrating a procedure of a hands-on request determination.

### DETAILED DESCRIPTION OF THE PREFERRED EMBODIMENTS

In PTL 1, the hands-on request requests a driver to switch a hands-off state to a hands-on state. In the hands-off state, the driver is not holding a steering wheel. In the hands-on state, the driver is holding the steering wheel. The future lateral acceleration is undergone by a vehicle when the vehicle travels in a curve in the hands-off state. According to PTL 1, it is possible to continue the hands-off state and prevent an unnecessary hands-on request from being made in a case where the vehicle undergoes small lateral acceleration, for example, when traveling at low speed in a traffic jam.

[PTL 1] WO 2023/100469

Incidentally, in a case where there is no median strip between the own vehicle lane and the opposing lane or in a case where the own vehicle lane and the opposing lane are separated by intermittent poles or wire ropes, it is undesirable to continue hands-off control that causes the own vehicle to travel in the hands-off state.

The present disclosure has been devised to solve the problem described above. A main object of the present disclosure is for a vehicle control device that performs hands-off control to notify a hands-on request in a case where it is undesirable to continue the hands-off control.

A means for solving the problem described above is as below.

A vehicle control device is applicable to a vehicle including a steering wheel and a notification device. The notification device notifies a request to a driver of an own vehicle. The vehicle control device performs hands-off control that causes the own vehicle to travel in a hands-off state in which the driver is not holding the steering wheel. The vehicle control device outputs a hands-on request to the notification device on the basis that (i) the hands-off control is being performed and (ii) there is a potential for at least a portion of a vehicle traveling in an own vehicle lane in which the own vehicle is traveling and at least a portion of a vehicle traveling in an opposing lane to enter each other's lanes. The hands-on request requests transition to a hands-on state in which the driver is holding the steering wheel.

According to the configuration, the vehicle control device is applied to the vehicle including the steering wheel and the notification device and performs the hands-off control that drives the own vehicle in the hands-off state.

Here, the hands-on request is output to the notification device on the basis that (i) the hands-off control is being performed and (ii) there is a potential for at least a portion of a vehicle traveling in an own vehicle lane in which the own vehicle is traveling and at least a portion of a vehicle traveling in an opposing lane to enter each other's lanes. The notification device then notifies the hands-on request to the driver. It is thus possible to notify the hands-on request in a case where it is undesirable to continue the hands-off control.

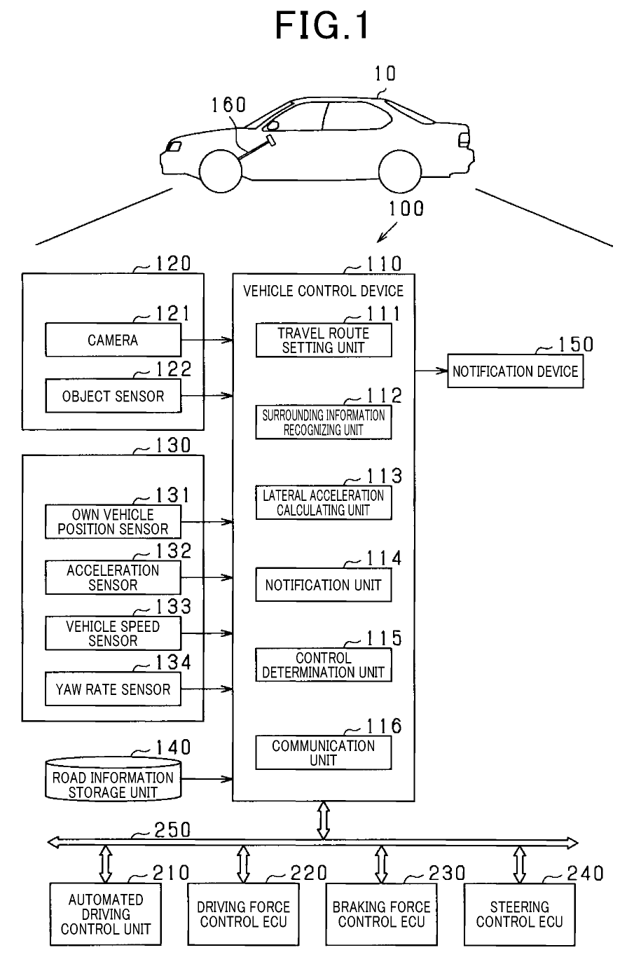

Hereinafter, an embodiment of a vehicle control device that is applied to a vehicle will be described based on FIGS. 1 to 12.

### Configuration of Vehicle Control Device 110

As illustrated in FIG. 1, a vehicle 10 (also referred to as “an own vehicle 10” below) includes an automated driving control system 100, a steering wheel 160, and a notification device 150. The vehicle 10 is capable of automated driving and human driving. In automated driving, the vehicle 10 is automatedly steered and driven even though the steering wheel 160 for a driving operation on the vehicle 10 is not operated by a driver. In addition, automated driving also has a mode in which a driver takes charge of steering and acceleration and deceleration are automatedly controlled. In human driving, the steering wheel 160 is operated by a driver to steer and drive the vehicle 10.

In the present embodiment, the automated driving control system 100 includes a vehicle control device 110, a surrounding sensor 120, an internal sensor 130, a road information storage unit 140, an automated driving control unit 210, a driving force control ECU (Electronic Control Unit) 220, a braking force control ECU 230, and a steering control ECU 240. The vehicle control device 110, the automated driving control unit 210, the driving force control ECU 220, the braking force control ECU 230, and the steering control ECU 240 are connected through an vehicle-mounted network 250.

The surrounding sensor 120 (corresponding to an opposing lane sensor) obtains surrounding information about the outside of the vehicle necessary for automated driving. The surrounding sensor 120 includes, for example, a camera 121 and an object sensor 122. The camera 121 images the region around the own vehicle 10 to obtain an image. The object sensor 122 detects the situation around the own vehicle 10. Examples of the object sensor 122 include object sensors such as a laser radar, a millimeter wave radar, and an ultrasonic wave sensor that use reflected waves. The surrounding sensor 120 detects another vehicle traveling in an adjacent lane that is adjacent to an own vehicle lane in which the vehicle 10 is traveling.

The internal sensor 130 includes an own vehicle position sensor 131, an acceleration sensor 132, a vehicle speed sensor 133, and a yaw rate sensor 134. The own vehicle position sensor 131 detects the current position of the vehicle 10. Examples of the own vehicle position sensor 131 include a global navigation satellite system(s) (GNSS), a gyro sensor, and the like.

The acceleration sensor 132 detects the acceleration of the vehicle 10. The acceleration sensor 132 includes, for example, a longitudinal acceleration sensor that detects the longitudinal acceleration of the vehicle 10 in the longitudinal direction and a lateral acceleration sensor that detects the lateral acceleration of the vehicle 10. The vehicle speed sensor 133 detects the current driving speed (referred to as “own vehicle speed V1” below) of the vehicle 10. The yaw rate sensor 134 detects the yaw rate (angular speed of rotation) of the vehicle 10 around the vertical axis at the center of gravity. It is possible to use, for example, a gyro sensor as the yaw rate sensor 134. The surrounding sensor 120 and the internal sensor 130 input the various kinds of obtained data to the vehicle control device 110.

The road information storage unit 140 stores detailed road information or the like regarding a road in which the vehicle 10 is scheduled to travel. The road information includes, for example, pieces of information about the number of lanes, the width of a lane, the central coordinates of each lane, the position of a stop line, the position of a traffic light, the position of a guardrail, a road grade, the road type of a curve or a straight section, the radius of curvature of a curve, the length of a curved section, and the like.

The notification device 150 is a device that notifies various kinds of information to an occupant (chiefly a driver) of the vehicle 10 using an image and/or sound. The notification device 150 includes a display device and a speaker. It is possible to use, for example, a HUD (Head-Up Display) and a display device provided to the instrument panel as the display device. It is to be noted that “image” may include even a moving image or a character string.

The vehicle control device 110 includes a travel route setting unit 111, a surrounding information recognizing unit 112, a lateral acceleration calculating unit 113, a notification unit 114, a control determination unit 115, and a communication unit 116. The vehicle control device 110 includes a microcomputer and the like. The microcomputer includes a central processing unit (CPU), a RAM, and a ROM. The microcomputer executes programs installed in advance to implement the functions of these respective units. Some or all of the functions of these respective units may be, however, implemented by a hardware circuit.

The travel route setting unit 111 sets a route on which the vehicle 10 travels. More specifically, the travel route setting unit 111 sets a target travel route to a destination determined in advance using road information stored in the road information storage unit 140. The “target travel route” according to the present embodiment is not just a course to the destination. As the “target travel route” according to the present embodiment, a detailed route is indicated such as a travel lane or a travel position in a road.

The surrounding information recognizing unit 112 recognizes the surrounding information about the vehicle 10 using a detection signal of the surrounding sensor 120. More specifically, the surrounding information recognizing unit 112 recognizes the presence and the positions of the left and right lane lines (referred to as “lane markers” below) of the road in which the vehicle 10 is traveling, the presence, the position, and the instruction of a traffic light, the presence, the position, the size, the distance, the traveling direction, and the speed (referred to as “other vehicle speed V2” below) of another vehicle, the presence and the operation of the driver of another vehicle, the presence and the position of a person around another vehicle, and the like as the pieces of surrounding information based on an image captured by the camera 121 and an output signal of the object sensor 122. It is to be noted that the surrounding information recognizing unit 112 may obtain and recognize some or all of these pieces of information through wireless communication with a traffic light, an external server, or the like.

The lateral acceleration calculating unit 113 calculates future lateral acceleration undergone by the vehicle 10 when the vehicle 10 travels in a curve present in the traveling direction. Specifically, the lateral acceleration calculating unit 113 calculates future lateral acceleration during curve traveling based on the curvature of the curve and the vehicle speed of the vehicle 10.

The notification unit 114 notifies, to an occupant, various kinds of information such as a travel route, vehicle position information, and a request to the occupant using the notification device 150 capable of displaying an image and outputting sound. Depending on the driving situation of the vehicle 10, the notification unit 114 outputs a hands-on request to the notification device 150 (inputs a hands-on request to the notification device 150) in accordance with a process by the control determination unit 115. The hands-on request requests a hands-off state to be switched to a hands-on state (transition to the hands-on state) while automated driving (corresponding to hands-off control) in the hands-off state is currently being performed. The hands-off state is a state in which a driver is not holding the steering wheel 160. The hands-on state is a state in which a driver is holding the steering wheel 160.

The control determination unit 115 determines the content of control over the vehicle 10 depending on a result of the calculation of the lateral acceleration calculating unit 113 and outputs the content of control to the automated driving control unit 210 through the vehicle-mounted network 250 to control the vehicle 10. The communication unit 116 obtains, for example, traffic information, weather information, accident information, obstacle information, traffic regulation information, and the like from an unillustrated information center through an unillustrated antenna. The communication unit 116 may obtain various kinds of information from other vehicles through vehicle-to-vehicle communication. In addition, the communication unit 116 may obtain various kinds of information from a roadside unit provided at each of spots along a road through road-to-vehicle communication. The control determination unit 115 performs s hands-off control, for example, under the condition that the vehicle 10 is traveling in an expressway (a road exclusively for motor vehicles). It is possible to recognize that the vehicle 10 is traveling in an expressway based on a result detected by the own vehicle position sensor 131 and road information stored in the road information storage unit 140. The hands-off control controls the own vehicle 10 to travel, for example, such that the travel lane in which the own vehicle 10 is currently traveling is kept and the distance between a preceding vehicle and the own vehicle 10 is kept constant. In addition, the hands-off control controls the own vehicle 10 to travel at setting speed set by a driver in a case where there is no preceding vehicle.

The automated driving control unit 210 includes a microcomputer and the like. The microcomputer includes a central processing unit (CPU), a RAM, and a ROM. The microcomputer executes a program installed in advance to implement the automated driving function. The automated driving control unit 210 controls the driving force control ECU 220 and the braking force control ECU 230, and the steering control ECU 240, for example, to travel along a route decided by the travel route setting unit 111. For example, in a case where the vehicle 10 changes into a next lane (corresponding to an adjacent lane), the automated driving control unit 210 may deliver merging support such that the vehicle 10 travels to a reference line of the next lane from a reference line of the lane in which the vehicle 10 is traveling.

The driving force control ECU 220 is an electronic control unit that controls an actuator such as an engine which generates driving force for the vehicle 10. In a case where a driver performs human driving, the driving force control ECU 220 controls a power source that is an engine or an electric motor in response to the amount of operation on the accelerator pedal. Meanwhile, in a case where automated driving is performed, the driving force control ECU 220 controls the power source in response to required driving force calculated by the automated driving control unit 210.

The braking force control ECU 230 is an electronic control unit that controls a brake actuator which generates braking force for the vehicle 10. In a case where a driver performs human driving, the braking force control ECU 230 controls the brake actuator in response to the amount of operation on the brake pedal. Meanwhile, in a case where automated driving is performed, the braking force control ECU 230 controls the brake actuator in response to required braking force calculated by the automated driving control unit 210.

The steering control ECU 240 is an electronic control unit that controls a motor which generates steering torque for the vehicle 10. In a case where a driver performs human driving, the steering control ECU 240 controls the motor in response to an operation on the steering wheel and generates assist torque corresponding to the steering operation. This allows the driver to operate the steering wheel with less force and steer the vehicle 10. Meanwhile, in a case where automated driving is performed, the steering control ECU 240 controls the motor in response to a required steering angle calculated by the automated driving control unit 210, thereby achieving steering.

### Process by Vehicle Control Device 110

In automated driving, the travel route setting unit 111 creates a travel plan of the vehicle 10 up to several seconds ahead based on the current position detected by the own vehicle position sensor 131 and the position, the speed, or the like of another vehicle or the like around the vehicle 10. This travel plan includes a steering plan, an acceleration and deceleration plan, and the like of the vehicle 10 up to several seconds ahead.

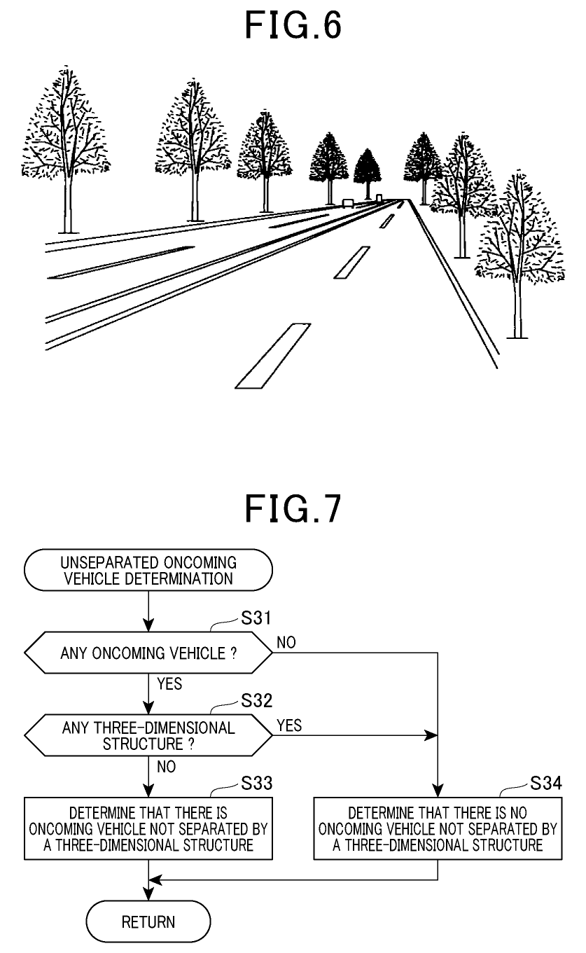

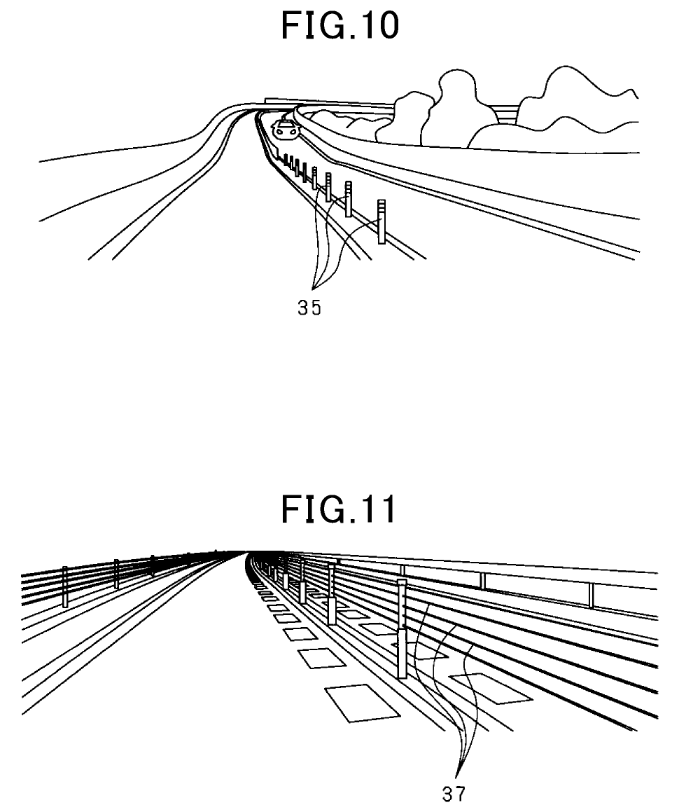

Incidentally, in a case where there is no median strip between the own vehicle lane and the opposing lane (see FIG. 6) or in a case where the own vehicle lane and the opposing lane are separated by intermittent poles 35 (see FIG. 10) or wire ropes 37 (see FIG. 11), it is undesirable to continue hands-off control that causes the own vehicle 10 to travel in the hands-off state.

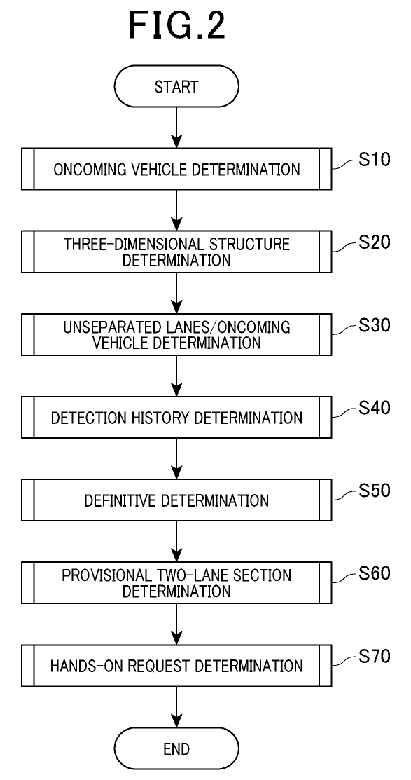

Accordingly, the vehicle control device 110 outputs a hands-on request in accordance with the procedure illustrated in the flowchart of FIG. 2. This series of processes is repeatedly performed by the vehicle control device 110 in a predetermined periodicity while hands-off control is currently being performed.

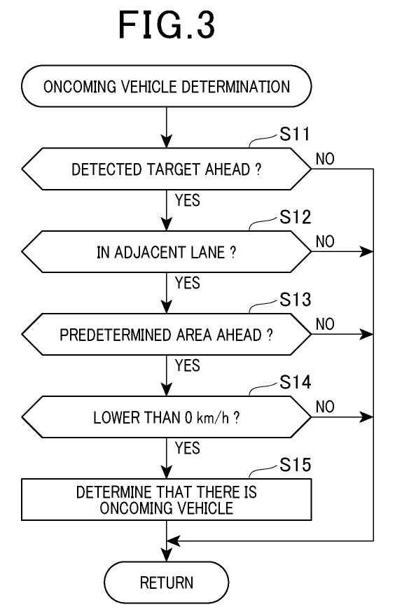

First, it is determined whether there is an oncoming vehicle in the opposing lane (S10). If described in detail, it is determined whether there is a detected target ahead of the own vehicle 10 based on a result detected by the surrounding sensor 120 as illustrated in FIG. 3 (S11). In a case where it is determined that there is a detected target ahead of the own vehicle 10 (S11: YES), it is determined whether the detected target is located in an adjacent lane based on a result detected by the surrounding sensor 120 and road information stored in the road information storage unit 140 (S12). In a case where it is determined that the detected target is located in an adjacent lane (S12: YES), it is determined whether the detected target is located in a predetermined area ahead of the own vehicle 10 based on a result detected by the surrounding sensor 120 (S13). In a case where it is determined that the detected target is located in a predetermined area ahead of the own vehicle 10 (S13: YES), it is determined whether the speed of the detected target is lower than 0 km/h (i.e., traveling in the direction opposite to the direction of the own vehicle 10) based on a result detected by the surrounding sensor 120 and a result detected by the vehicle speed sensor 133 (S14). In a case where it is determined that the speed of the detected target is lower than 0 km/h (S14: YES), it is determined that there is an oncoming vehicle (S15). In contrast, in a case where the determination of any of S11 to S14 results in a negative determination, it is not determined that there is an oncoming vehicle. After that, the flow returns to FIG. 2 and advances to the process of S20.

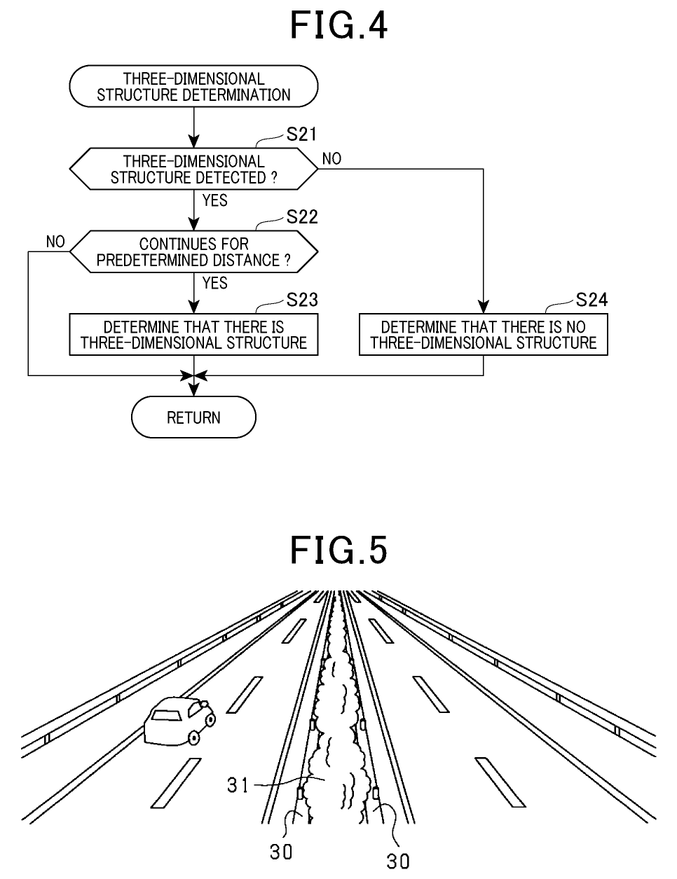

Subsequently, it is determined whether there is a three-dimensional structure between the own vehicle 10 and the opposing lane (S20). If described in detail, it is determined whether a three-dimensional structure has been detected that prevents even a portion of a vehicle traveling in the own vehicle lane and even a portion of a vehicle traveling in the opposing lane from entering each other's lanes based on an image obtained by the camera 121 as illustrated in FIG. 4 (S21). The three-dimensional structure includes a pair of concrete sections 30 and a plant 31. The pair of concrete sections 30 extends along the road in the middle of the road at predetermined height and the plant 31 is put between the pair of concrete sections 30, for example, as illustrated in FIG. 5. It is to be noted that the three-dimensional structure may include a concrete barrier, a guardrail, a steel barrier, and the like. In a case where the road has no median strip as illustrated in FIG. 6, no three-dimensional structure is detected. In a case where the road has no median strip, vehicles traveling in the own vehicle lane in which the own vehicle 10 is traveling and vehicles traveling in the opposing lane may enter each other's lanes. In a case where it is determined that a three- dimensional structure has been detected (S21: YES), it is determined whether the three-dimensional structure continues for a predetermined distance (S22). In a case where it is determined that the three-dimensional structure continues for a predetermined distance (S22: YES), it is determined that there is a three-dimensional structure (S23). In contrast, in a case where it is determined that the three-dimensional structure does not continue for a predetermined distance (S22: NO), the flow returns to FIG. 2 and advances to the process of S30. In addition, in a case where it is determined that no three-dimensional structure is detected (S21: NO), it is determined that there is no three-dimensional structure (S24). After that, the flow returns to FIG. 2 and advances to the process of S30.

Subsequently, it is determined whether the lanes are unseparated and there is an oncoming vehicle (S30). If described in detail, it is determined as illustrated in FIG. 7 whether the determination result of the process of S10 in FIG. 2 indicates that there is an oncoming vehicle (S31). In a case where it is determined that the determination result of S10 indicates that there is an oncoming vehicle (S31: YES), it is determined whether the determination result of the process of S20 in FIG. 2 indicates that there is a three-dimensional structure (S32). In a case where it is determined that the determination result of S20 indicates that there is no three-dimensional structure (S32: NO), it is determined that the lanes are unseparated and there is an oncoming vehicle, that is, there is an oncoming vehicle not separated by a three-dimensional structure (S33). After that, the flow returns to FIG. 2 and advances to the process of S40. In contrast, in a case where it is determined that the determination result of S10 indicates there is no oncoming vehicle (S31: NO) or it is determined that the determination result of S20 indicates there is a three-dimensional structure (S32: YES), it is determined that there is no oncoming vehicle not separated by a three-dimensional structure (S34). After that, the flow returns to FIG. 2 and advances to the process of S40.

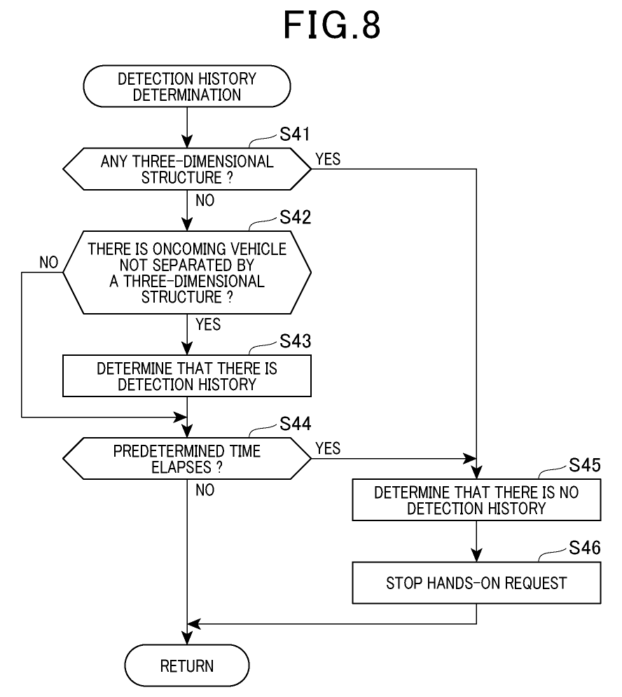

Subsequently, it is determined whether there is a detection history of an oncoming vehicle (S40). If described in detail, it is determined as illustrated in FIG. 8 whether the determination result of the process of S20 in FIG. 2 indicates that there is a three-dimensional structure (S41). In a case where it is determined that the determination result of S20 indicates that that there is no three-dimensional structure (S41: NO), it is determined whether the determination result of the process of S30 in FIG. 2 indicates that the lanes are unseparated and there is an oncoming vehicle (S42). In a case where it is determined that the determination result of S30 indicates that that the lanes are unseparated and there is an oncoming vehicle (S42: YES), it is determined that there is a detection history (S43). After that, the flow advances to the process of S44. In contrast, in a case where the determination of S42 results in a negative determination (S42: NO), the flow advances to the process of S44. Subsequently, it is determined whether a predetermined time elapses after it is determined that there is an oncoming vehicle (S44). In a case where it is determined that a predetermined time does not elapse after it is determined that there is an oncoming vehicle (S44: NO), the flow returns to FIG. 2 and advances to the process of S50. In contrast, in a case where it is determined that the determination result of S20 indicates that there is a three-dimensional structure (S41: YES) or in a case where it is determined that a predetermined time elapsed after it is determined that there is an oncoming vehicle (S44: YES), it is determined that there is no detection history and the result of the determination that the lanes are unseparated and there is an oncoming vehicle is reset (S45). Subsequently, the hands-on request to the notification device 150 is stopped (S46). Additionally, when stopping the hands-on request to the notification device 150, in a case where the hands-on request has already been output to the notification device 150, the hands-on request is stopped, and in a case where no hands-on request is output to the notification device 150, the state in which no hands-on request is output is kept. After that, the flow returns to FIG. 2 and advances to the process of S50.

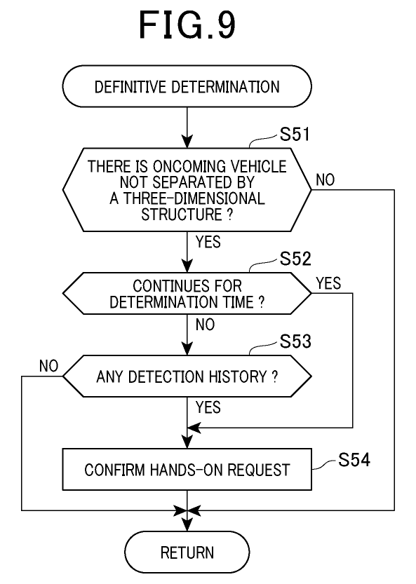

Subsequently, it is determined whether to make a definitive determination (S50). If described in detail, it is determined as illustrated in FIG. 9 whether the determination result of the process of S30 in FIG. 2 indicates that the lanes are unseparated and there is an oncoming vehicle (S51). In a case where it is determined that the determination result of S30 indicates that the lanes are unseparated and there is an oncoming vehicle (S51: YES), it is determined whether the state in which it is determined that the lanes are unseparated and there is an oncoming vehicle continues for a determination time (S32). In a case where it is determined that this state does not continue for a determination time (S52: NO), it is determined whether the determination result of the process of S40 in FIG. 2 indicates that there is a detection history (S53). In a case where it is determined that the determination result of S40 indicates that there is a detection history (S53: YES), the hands-on request is confirmed (S54). That is, in a case where a predetermined number (two in the present embodiment) of oncoming vehicles or more are detected in the opposing lane by the surrounding sensor 120 within a predetermined time, the hands-on request is confirmed. In contrast, in a case where a predetermined number of oncoming vehicles or more are not detected in the opposing lane by the surrounding sensor 120 within a predetermined time, the output of the hands-on request to the notification device 150 is stopped (see FIG. 8). In contrast, in a case where it is determined that this state continued for a determination time (S52: YES), the hands-on request is confirmed (S54). In addition, in a case where it is determined that the determination result of S40 indicates that there is no detection history (S53: NO), the flow returns to FIG. 2 and advances to the process of S60. In addition, in a case where it is determined that the determination result of S30 indicates that there is no oncoming vehicle not separated by a three-dimensional structure (S51: NO), the flow returns to FIG. 2 and advances to the process of S60.

Subsequently, it is determined whether the road in which the own vehicle 10 is traveling is a provisional two-lane section (S60). If described in detail, in a case where the own vehicle lane and the opposing lane are adjacent and it is determined that the own vehicle lane and the opposing lane are separated by the intermittent poles 35 based on an image obtained by the camera 121 as illustrated in FIG. 10, it is determined that the road is a provisional two-lane section. In addition, in a case where the own vehicle lane and the opposing lane are adjacent and it is determined that the own vehicle lane and the opposing lane are separated by the wire ropes 37 based on an image obtained by the camera 121 as illustrated in FIG. 11, it is determined that the road is a provisional two-lane section. In the provisional two-lane section, at least the portion of the vehicle traveling in the own vehicle lane in which the own vehicle 10 is traveling and at least the portion of the vehicle traveling in the opposing lane to enter each other's lanes. After that, the flow returns to FIG. 2 and advances to the process of S70. Additionally, in a case where the process of S60 is performed before the process of S10 and it is determined that the road is a provisional two-lane section, the flow may advance to the process of S70. In a case where it is determined that the road is not a provisional two-lane section, the flow may advance to the process of S10.

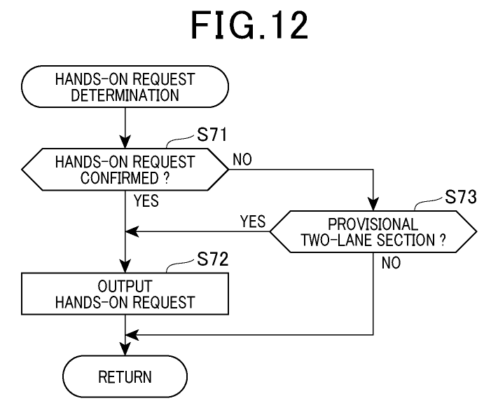

Subsequently, it is determined whether to output a hands-on request (S70). If described in detail, it is determined as illustrated in FIG. 12 whether the hands-on request is confirmed in the process of S70 in FIG. 2 (S71). In a case where it is determined that the hands-on request is confirmed (S71: YES), the hands-on request is output to the notification device 150 (S72). After that, the flow returns to FIG. 2 and brings this series of processes to an end temporarily (END). In contrast, in a case where it is determined that the hands-on request is not confirmed (S71: NO), it is determined whether the determination result of the process of S60 in FIG. 2 indicates that the road in which the own vehicle 10 is traveling is a provisional two-lane section (S73). In a case where the determination of S73 results in an affirmative determination (S73: YES), the flow advances to the process of S72. In contrast, in a case where the determination of S73 results in a negative determination (S73: NO), the flow returns to FIG. 2 and brings this series of processes to an end temporarily (END).

The present embodiment described in detail so far has the following advantages.

The vehicle control device 110 outputs a hands-on request to the notification device 150 on the basis that hands-off control is currently being performed and at least a portion of a vehicle traveling in an own vehicle lane in which the own vehicle is traveling and at least a portion of a vehicle traveling in an opposing lane to enter each other's lanes. The notification device 150 then notifies the hands-on request to a driver. It is thus possible to notify the hands-on request in a case where it is undesirable to continue the hands-off control.

The vehicle control device 110 outputs a hands-on request to the notification device 150 in a case where hands-off control is currently being performed, a predetermined number of oncoming vehicles or more are detected in the opposing lane by the surrounding sensor 120 within a predetermined time, and it is determined that a three-dimensional structure (e.g., the pair of concrete sections 30 and the plant 31) that prevents even the portion of the vehicle traveling in the own vehicle lane and even the portion of the vehicle traveling in the opposing lane from entering each other's lanes is not present between the own vehicle 10 and the opposing lane based on an image obtained by the camera 121. Such a configuration makes it possible to output a hands-on request to the notification device 150 in a case where a situation in which oncoming vehicles are traveling in the opposing lane continues and the three-dimensional structure does not prevent even the portion of the vehicle traveling in the own vehicle lane and even the portion of the vehicle traveling in the opposing lane from entering each other's lanes.

The vehicle control device 110 stops the output of a hands-on request to the notification device 150 in a case where a predetermined number of oncoming vehicles or more are not detected in the opposing lane by the surrounding sensor 120 within a predetermined time. Specifically, in a case where it is not determined that the lanes are unseparated and there is an oncoming vehicle in the state in which there is a detection history before the predetermined time elapses, that is, in a case where two or more oncoming vehicles are not detected within the predetermined time, the output of the hands-on request to the notification device 150 is stopped. In spite of a temporary situation in which an oncoming vehicle travels in the opposing lane, it is therefore possible to prevent an unnecessary hands-on request to be output in a case where that situation does not continue.

The vehicle control device 110 stops the output of the hands-on request to the notification device 150 in a case where it is determined that there is a three-dimensional structure between the own vehicle 10 and the opposing lane based on an image obtained by the camera 121. Therefore, in a case where the three-dimensional structure prevents even the portion of the vehicle traveling in the own vehicle lane and even the portion of the vehicle traveling in the opposing lane from entering each other's lanes, that is, in a case where the three-dimensional structure completely (in a necessary and sufficient manner) prevents vehicles traveling in the own vehicle lane and vehicles traveling in the opposing lane from entering each other's lanes, it is possible prevent an unnecessary hands-on request from being output.

The vehicle control device 110 outputs a hands-on request to the notification device 150 in a case where the own vehicle lane and the opposing lane are adjacent and it is determined that the own vehicle lane and the opposing lane are separated by the intermittent poles 35 or the wire ropes 37 based on an image obtained by the camera 121. Such a configuration makes it possible to output a hands-on request to the notification device 150 in a case where the own vehicle lane and the opposing lane are adjacent and are insufficiently separated like a provisional two-lane section or the like.

Additionally, it is also possible to modify and carry out the embodiment as below. The same portions as those of the embodiment will be denoted with the same reference signs and the description thereof will be thus incorporated.

When the vehicle 10 is traveling in a curve, a process of the flowchart of FIG. 3 may be performed by taking the curvature of the curve into consideration. It is possible to calculate the curvature of a curve, for example, based on at least one of a result detected by the camera 121 and road information stored in the road information storage unit 140.

Hands-off control may be performed during a traffic jam in the own vehicle lane.

Additionally, it is also possible to execute the embodiment and the respective modification examples in combination within a combinable range.

Hereinafter, characteristic configurations extracted from the respective embodiments and the respective modification examples described above will be described.

### Configuration 1

A vehicle control device applicable to a vehicle including a steering wheel and a notification device, the notification device notifying a request to a driver of an own vehicle, in which

the vehicle control device comprising:

at least one of (i) a circuit and (ii) a processor with a memory storing computer program code executable by the processor, the at least one of the circuit and the processor configured to cause the vehicle control device to:

perform hands-off control that causes the own vehicle to travel in a hands-off state in which the driver is not holding the steering wheel; and

output a hands-on request to the notification device on a basis that (i) the hands-off control is being performed and (ii) there is a potential for at least a portion of a vehicle traveling in an own vehicle lane in which the own vehicle is traveling and at least a portion of a vehicle traveling in an opposing lane to enter each other's lanes, the hands-on request requesting transition to a hands-on state in which the driver is holding the steering wheel.

### Configuration 2

The vehicle control device according to Configuration 1, in which

the own vehicle further includes an opposing lane sensor and a camera, the opposing lane sensor detecting an oncoming vehicle traveling in the opposing lane, the camera imaging a region around the own vehicle to obtain an image, and

the at least one of the circuit and the processor is further configured to cause the vehicle control device to output the hands-on request to the notification device in a case where (i) the hands-off control is being performed, (ii) a predetermined number of the oncoming vehicles or more are detected in the opposing lane by the opposing lane sensor within a predetermined time, and (iii) absence of a three-dimensional structure between the own vehicle and the opposing lane is determined based on the image obtained by the camera, the three-dimensional structure preventing even a portion of a vehicle traveling in the own vehicle lane and even a portion of a vehicle traveling in the opposing lane from entering each other's lanes.

### Configuration 3

The vehicle control device according to Configuration 2, in which the at least one of the circuit and the processor is further configured to cause the vehicle control device to stop an output of the hands-on request to the notification device in a case where the predetermined number of the oncoming vehicles or more are not detected in the opposing lane by the opposing lane sensor within the predetermined time.

### Configuration 4

The vehicle control device according to Configuration 2 or 3, in which the at least one of the circuit and the processor is further configured to cause the vehicle control device to stop an output of the hands-on request to the notification device in a case where presence of the three-dimensional structure between the own vehicle and the opposing lane is determined based on the image obtained by the camera.

### Configuration 5

The vehicle control device according to Configuration 1 or 2, in which

the own vehicle further includes a camera which images a region around the own vehicle to obtain an image, and

the at least one of the circuit and the processor is further configured to cause the vehicle control device to output the hands-on request to the notification device in a case where (i) the own vehicle lane and the opposing lane are adjacent and (ii) separation of the own vehicle lane and the opposing lane by intermittent poles or a wire rope is determined based on the image obtained by the camera.

### Configuration 6

A vehicle including:

the vehicle control device according to any one of Configurations 1 to 5;

the steering wheel; and

the notification device.

### Configuration 7

A vehicle control method for a vehicle including a steering wheel and a notification device, the notification device notifying a request to a driver of an own vehicle, in which

the vehicle control method comprising:

performing hands-off control that causes the own vehicle to travel in a hands-off state in which the driver is not holding the steering wheel; and

outputting a hands-on request to the notification device on a basis that (i) the hands-off control is being performed and (ii) there is a potential for at least a portion of a vehicle traveling in an own vehicle lane in which the own vehicle is traveling and at least a portion of a vehicle traveling in an opposing lane to enter each other's lanes, the hands-on request requesting transition to a hands-on state in which the driver is holding the steering wheel.

1. A vehicle control device applicable to a vehicle including a steering wheel and a notification device, the notification device notifying a request to a driver of an own vehicle, wherein
the vehicle control device comprising:
at least one of (i) a circuit and (ii) a processor with a memory storing computer program code executable by the processor, the at least one of the circuit and the processor configured to cause the vehicle control device to:
perform hands-off control that causes the own vehicle to travel in a hands-off state in which the driver is not holding the steering wheel; and
output a hands-on request to the notification device on a basis that (i) the hands-off control is being performed and (ii) there is a potential for at least a portion of a vehicle traveling in an own vehicle lane in which the own vehicle is traveling and at least a portion of a vehicle traveling in an opposing lane to enter each other's lanes, the hands-on request requesting transition to a hands-on state in which the driver is holding the steering wheel.

2. The vehicle control device according to claim 1, wherein
the own vehicle further includes an opposing lane sensor and a camera, the opposing lane sensor detecting an oncoming vehicle traveling in the opposing lane, the camera imaging a region around the own vehicle to obtain an image, and
the at least one of the circuit and the processor is further configured to cause the vehicle control device to output the hands-on request to the notification device in a case where (i) the hands-off control is being performed, (ii) a predetermined number of the oncoming vehicles or more are detected in the opposing lane by the opposing lane sensor within a predetermined time, and (iii) absence of a three-dimensional structure between the own vehicle and the opposing lane is determined based on the image obtained by the camera, the three-dimensional structure preventing even a portion of a vehicle traveling in the own vehicle lane and even a portion of a vehicle traveling in the opposing lane from entering each other's lanes.

3. The vehicle control device according to claim 2, wherein the at least one of the circuit and the processor is further configured to cause the vehicle control device to stop an output of the hands-on request to the notification device in a case where the predetermined number of the oncoming vehicles or more are not detected in the opposing lane by the opposing lane sensor within the predetermined time.

4. The vehicle control device according to claim 2, wherein the at least one of the circuit and the processor is further configured to cause the vehicle control device to stop an output of the hands-on request to the notification device in a case where presence of the three-dimensional structure between the own vehicle and the opposing lane is determined based on the image obtained by the camera.

5. The vehicle control device according to claim 1, wherein
the own vehicle further includes a camera which images a region around the own vehicle to obtain an image, and
the at least one of the circuit and the processor is further configured to cause the vehicle control device to output the hands-on request to the notification device in a case where (i) the own vehicle lane and the opposing lane are adjacent and (ii) separation of the own vehicle lane and the opposing lane by intermittent poles or a wire rope is determined based on the image obtained by the camera.

6. A vehicle comprising:
the vehicle control device according to claim 1;
the steering wheel; and
the notification device.

7. A vehicle control method for a vehicle including a steering wheel and a notification device, the notification device notifying a request to a driver of an own vehicle, wherein
the vehicle control method comprising:
performing hands-off control that causes the own vehicle to travel in a hands-off state in which the driver is not holding the steering wheel; and
outputting a hands-on request to the notification device on a basis that (i) the hands-off control is being performed and (ii) there is a potential for at least a portion of a vehicle traveling in an own vehicle lane in which the own vehicle is traveling and at least a portion of a vehicle traveling in an opposing lane to enter each other's lanes, the hands-on request requesting transition to a hands-on state in which the driver is holding the steering wheel.
